(19) United States
(12) Patent Application Publication
(10) Pub. No.: US 2008/0102849 A1
(43) Pub. Date: May 1, 2008

(54) BEACON AIDED LOW COMPLEXITY DISTRIBUTED AUTONOMOUS DYNAMIC FREQUENCY SELECTION

(76) Inventors: James Neel, Forest, VA (US); Jeffrey Reed, Blacksburg, VA (US); Robert Gilles, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/623,428

(22) Filed: Jan. 16, 2007

Related U.S. Application Data
(60) Provisional application No. 60/862,882, filed on Oct. 25, 2006.

(51) Int. Cl. H04Q 7/20

(52) U.S. Cl. 455/452.2

(57) ABSTRACT

When implemented on a single access point, the system autonomously adjusts the operating channel of an 802.11h compliant network so the network operates on the channel with the least interference. When deployed on the access nodes in a campus or urban setting, the system rapidly converges to a stable interference-minimizing frequency re-use pattern with the average reduction in interference realized by each 802.11 cluster in the range of 19 dB (as device density increases, the expected reduction in interference increases with the exact gain in interference reduction a function of the specific propagation environment and network topology). Significant, though smaller, expected reductions in interference are also realized by legacy systems which are not implementing the algorithm but operating in the presence of the enhanced access points. When new access points are added to the network, the network automatically converges to a near optimal frequency reuse pattern. This is accomplished without any message passing between access nodes, without any adjustments to the existing 802.11 protocol, without user guidance, without prior or externally generated knowledge of the environment or network, and with minimal additional computational complexity at the access node.

### CROSS REFERENCE TO RELATED APPLICATIONS

This application claims priority to U.S. Provisional Application 60/862,882 filed Oct. 25, 2006, and the complete contents thereof are herein incorporated by reference.

### GOVERNMENT LICENSE RIGHTS

The U.S. Government has a paid-up license in this invention and the right in limited circumstances to require the patent owner to license others on reasonable terms as provided for by the terms of Office of Naval Research Grant Number N00014-03-1-0629 and National Science Foundation Integrated Research and Education in Advanced Networking—an IGERT program Grant Number DGE-998 7586.

### BACKGROUND OF THE INVENTION

1. Field of the Invention

The present application generally relates to cognitive radios and, more particularly, to a low-complexity autonomous dynamic frequency selection (DFS) system suitable for use in infrastructure-based wireless networks.

2. Background Description

While WiFi coverage has become less of a problem, external network interference has emerged as a significant problem as the networks fight for access to a limited number of channels (and frequently, the same channel!). In theory, this interference problem could be ameliorated by applying a frequency reuse pattern to the networks—a seemingly easily implemented approach as 802.11b has three nonoverlapping channels (1, 6, and 11) and 802.11a has eight minimally interfering channels in the US (nineteen in Europe) which are explicitly intended to facilitate frequency reuse in a minimally interfering manner. However, most people never modify their access points from the factory settings so many access points operate on the same pre-set channel.

An obvious technique to solve this problem is to have a network which is experiencing interference change its operating frequency when it experiences too much interference. Several existing patents cover such an approach. For example, U.S. Pat. No. 7,110,374 to Malhorta defines a method of selecting a new frequency based on the frequency on which the least amount of signaling is observed. U.S. Pat. No. 7,158,759 to Hansen defines a method and apparatus for dynamic frequency selection wherein the access point coordinates interference measurements with its client devices before finding and then messaging to the clients a new operating band. U.S. Pat. No. 6,914,876 to Rotstein applies energy detection techniques to all received signals in the frequency and wavelet domains to adapt to channels with less perceived interference.

However, when deployed in the access nodes of coexisting 802.11 networks, the adaptations of cognitive radios yield an interactive decision problem where the adaptations of one access node impacts the adaptations of other access nodes. Because of the difficulty in predicting the outcome of this interactive process, no existing patented methods address the issue of performance in light of this interactive decision process. The proposed method disclosed herein, in addition to proposing a new metric by which to guide the adaptations of access nodes implementing DFS, also addresses this interaction process and demonstrates that for this method the interaction reduces average network interference.

In the academic literature, several authors have proposed modeling the interactive decision problems that result from independent DFS adaptations with game theory. By leveraging the potential game model, we proposed in J. Neel, R. Menon, A. MacKenzie, J. Reed, R. Gilles, “Interference Reducing Networks,” Submitted to IEEE JSAC on Adaptive, Spectrum Agile and Cognitive Wireless Networks (referred to hereinafter as Neel et al. (1), draft available at www.mprg.org/gametheory/) a framework—the interference reducing network (IRN)—for cognitive radio design that ensures the selfish adaptations of interacting cognitive radios converge to a low interference state. In brief, the framework requires each adaptation made by a cognitive radio to reduce the sum network interference. While it is easy to satisfy this condition with networks that employ centralized decision processes or elaborate observation sharing processes, this disclosure proposes a distributed and autonomous dynamic frequency selection algorithm (DFS) suitable for use in 802.11h that satisfies the IRN framework without cooperation between access nodes.

Many authors have attacked the problem of DFS, or more generally dynamic spectrum access (DSA), by requiring explicit coordination between access nodes. For instance, J. Zhao, H. Zheng, G. Yang, “Distributed Coordination in Dynamic Spectrum Allocation Networks,” DySPAN 2005, November 2005 pp. 269-278, considers a network of orthogonal channels where adaptive secondary users coordinate their adaptations via a common channel. Etkin, A. Parekh, D. Tse, “Spectrum Sharing for Unlicensed Bands,” DySPAN2005, November 2005 pp. 251-258, considers a system wherein optimal frequency/power allocations are achieved by employing punishment strategies. As part of a solution to network formation problem M. Steenstrup, “Opportunistic use of radio-frequency spectrum: a network perspective,” DySPAN2005, November 2005 pp. 638-641, utilizes a central controller to assign frequencies to each link in the network. N. Nie, C. Comaniciu, “Adaptive channel allocation spectrum etiquette for cognitive radio networks,” DySPAN2005, November 2005 pp. 269-278, considers a DSA scheme wherein radios must share information over a common channel to compute the interference levels each radio would induce to other radios in order to evaluate its goal (U2 in Nie et al.). While this has the virtue of being both an exact potential game and an IRN, it requires significant overhead to distribute the information needed to evaluate the goal and requires that decisions are made sequentially. For DSA systems where spreading codes adapted (viewed in the context of signal space, spreading code adaptation algorithms could be directly applied to DFS problems), C. Sung, K. Leung, “On the stability of distributed sequence adaptation for cellular asynchronous DS-CDMA systems,” IEEE Transactions on Information Theory, vol. 49, no. 7, July 2003, pp. 1828-1831, presents an algorithm where each radio's goal incorporates the interference measurements of all other radios in the system. C. Sung, K. W. Shum and K. Leung, “Multi-objective power control and signature sequence adaptation for synchronous CDMA systems—a game-theoretic viewpoint”, Proceedings of the IEEE International Symposium on Information Theory, July 2003, p. 335, J. Hicks, A. MacKenzie, J. Neel, J. Reed, “A Game Theory Perspective on Interference Avoidance,” IEEE GlobeCom, vol. 1, December 2004, pp. 257-261, and S. Ulukus and R. D. Yates, “Iterative construction of optimum signature sequence sets in synchronous CDMA systems,” IEEE Transactions on Information Theory, vol. 47, no. 5, July 2001, pp. 1989-1998, consider spreading code adaptations where each access node is isolated in frequency and spreading codes are chosen so as to minimize the interference of clients/mobiles are—a situation analogous in signal space to DFS applied to the clients in a single isolated cluster.

Nie et al. also propose another goal (or utility function) for DSA (U1) that is identical to the goal used in this paper (equation (1)). However, because Nie et al. place no restrictions on the observation mechanism, Nie et al. are unable to show that system forms an exact potential game which would permit the use of a simple distributed and autonomous algorithm. Instead Nie et al. employs a no-regret learning algorithm wherein the radios autonomously try every possible frequency and then adapt to frequencies that yield the best weighted cumulative utility and show that the algorithm converges to a mixed strategy equilibrium—a less than optimal result as mixed strategies in frequency selection imply continuous probabilistic adaptation.

### SUMMARY OF THE INVENTION

According to the present invention, there is provided a low-complexity autonomous distributed DFS system suitable for use in infrastructure networks where all access nodes regularly broadcast a signal (beacon) at a common power level. This system converges to a near optimal frequency reuse pattern which has been experimentally shown to yield an average reduction in average network interference power of 19 dB.

This is done:
Without any messages exchanged between access points.
Without adaptation coordination between access nodes
Without any exogenous knowledge
Without a centralized controller
By requiring each access node to do the following activities:
a) Each AN regularly listens for this beacon on its operating channel and on alternate channels.
b) When a beacon from another cluster's AN is detected, the listening AN notes the received power of this beacon, the channel on which it was detected, and the id.
c) With the data from b), each AN constructs an interference table (IT) which tracks the beacon signal energy detected over several channels
d) Intermittently, the AN searches its IT to switch to the channel with the least observed beacon energy (possibly its current channel).
e) When a channel change occurs, the AN signals its client/subscriber devices of the new channel.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a graph illustrating steady-state channels selected for a random distribution of access nodes with random initial channels in the 5.47-5.725 GHz band when using RTS/CTS messages as the beacon signal;

FIGS. 2A, 2B and 2C are graphs illustrating instantaneous statistics for the network of FIG. 1;

FIGS. 3A, 3B and 3C are graphs illustrating simulations where channel selection criteria is the lowest channel that is observed to have less RTS/CTS signal power;

FIGS. 4A, 4B and 4C are graphs illustrating simulations where channel selection criteria is the highest channel that is observed to have less RTS/CTS signal power;

FIGS. 5A, 5B and 5C are graphs illustrating instantaneous statistics with policy variations;

FIGS. 6A, 6B and 6C are graphs illustrating simulation where ten radios are constrained to the lower set of channels;

FIGS. 7A, 7B and 7C are graphs illustrating the impact of asynchronous decision timings;

FIGS. 8A, 8B and 8C are graphs illustrating the algorithm with private frequency references;

FIGS. 9A, 9B and 9C are graphs illustrating the algorithm with stochastic estimations;

FIGS. 10A, 10B and 10C are graphs illustrating the algorithm with stochastic estimations and a small adaption threshold of −85 dBm; and

FIG. 11 is a graph illustrating aggregate statistics.

FIG. 12 is a schematic drawing illustrating a typical deployment scenario.

FIG. 13 is a graph illustrating the processes to be implemented on an access point.

### DETAILED DESCRIPTION OF THE PREFERRED EMBODIMENTS OF THE INVENTION

### Interference Reducing Networks

Modifying the notation of Neel et al. (1) to be DFS (dynamic frequency selection) specific, we can model a collection of adaptive access points by the tuple, <N, F, {uᵢ}, {dᵢ}, T> where N represents the set of n cognitive radios, F is the frequency space formed as F=F₁× . . . ×Fₙ where Fᵢ specifies the frequencies available to cognitive radio iεN, {uᵢ}, uᵢ:F→i, is the set of goals that inform the cognitive radios' decision processes, dᵢ:F→Fᵢ, implemented at the times that guides a radio's adaptations and the decision timings, T, at which the decisions are implemented. Following the notation of Neel et al. [1], such a network is said to be an interference reducing network (IRN) if all adaptations decrease the value of the sum of observed interference levels

$$Φ ( f ) = {\sum }_{i ∈ N} {I}_{i} ( f )$$

where Iᵢ(f) is the interference observed by radio i when the frequency vector fεF is implemented by N.

For our DFS algorithm we model the goal of our radios as minimizing perceived interference as shown in (1)

$${u}_{i} ( f ) = - {I}_{i} ( f ) = - {\sum }_{k ∈ N \backslash i} {g}_{ki} {p}_{k} σ ( {f}_{i ,} {f}_{k} ) \qquad ( 1 )$$

where σ measures the fractional interference, i.e., σ(fᵢ,fₖ)=max{B−|fᵢ−fₖ|,0}/B , fᵢ is the frequency of cognitive radio i's RTS/CTS signal, pₖ is the transmission power of radio k's waveform, B is the channel bandwidth, and gₖᵢ is the link gain from the transmission source of radio k's signal to the point where radio i measures its interference. Φ(f) can then be expressed as in (2).

$$Φ ( f ) = {\sum }_{i ∈ N} {\sum }_{k ∈ N \backslash i} {g}_{ki} {p}_{k} σ ( {f}_{k} , {f}_{i} ) \qquad ( 2 )$$

Neel et al. [1] state that an IRN can be realized in a distributed and autonomous fashion by selfish interference minimizing radios if adaptations are made by only one radio at a time if the condition of bilateral symmetric interference (BSI) holds which happens if gₖᵢpₖσ(fᵢ,fₖ)=gᵢₖpᵢ(fₖ,fᵢ)∀fₖεfₖ,∀fᵢεFᵢ. BSI implies that a network is an IRN for unilateral adaptations because BSI implies that <N, F, {uᵢ}> is an exact potential game (J. Neel. J. Reed, A. MacKenzie, “Cognitive Radio Network Performance Analysis,” in Cognitive Radio Technology, B. Fette, ed., Elsevier August, 2006).

An exact potential game is a normal form game for which there exists a function, called the exact potential function, V:Ω→□ such that uᵢ(\hat{f}ᵢ,f₋ᵢ)−uᵢ(fᵢ,f₋ᵢ)=V(\hat{f}ᵢ,f₋ᵢ)−V(fᵢ,f₋ᵢ)∀iεN,fᵢ,\tilde{f}ᵢεFᵢ where f₋ᵢ refers to the n−1 dimensional vector formed by excluding the contribution of i. By examining this definition, it is apparent that when selfish unilateral adaptations are made in an exact potential game, V constitutes a monotonically increasing sequence. When BSI holds, Φ(f)=−2V(f) [1], so a monotonically increasing V implies a monotonically decreasing Φ(f) making the network an IRN. This monotonicity property can then be used to prove the convergence of all selfish decision rules with unilateral timings.

### A DFS IRN Algorithm

Consider a network of cognitive radios where each cognitive radio acts as an access node and observes the spectral energy of the RTS/CTS messages transmitted by the other access nodes in the network. [1] shows that if the network implements DFS under the following conditions, the network is an IRN:

C1: All messages are transmitted at the same power level.

C2: All adaptations made by iεN increase the value of (1) based on observations of the other cognitive radios' messages.

C3: All waveforms have the same bandwidth B.

C4: At any instance only a single radio adapts.

Note that C1 assures us that pₖ=pᵢ, C2 assures symmetric link gains between decision makers; C3 assures us that σ(fᵢ,fₖ)=σ(fₖ,fᵢ). Thus gₖᵢpₖσ(fᵢ,fₖ) gᵢₖpᵢσ(fₖ,fᵢ)∀fₖεFₖ,∀fᵢεFᵢ and BSI is satisfied. C4 then assures us of a monotonically decreasing Φ(f) when a radio's adaptations increase (I) which makes the network an IRN. C4, however, is not a requirement for the proper operation of the algorithm and is merely an analysis conceit to establish the existence of an IRN. As shown in Neel et al. (1), any exact potential game with a finite action space (in this case a finite number of channels) forms an absorbing Markov chain under asynchronous timing (where adaptations are uncoordinated so that a subset of radios might adapt simultaneously) with absorbing states coincident with the maximizers of V.

### An 802.11h Application

As Neel et al. [1] assert, since the only requirement on the decision process of the cognitive radio is that adaptations increase (1) in order to decrease (2), great variation in the implementation of the decision process is permissible. In the following, we assume that each access node implements the following steps:
a) Each AN regularly listens for the common beacon on its operating channel and on alternate channels.
b) When a beacon from another cluster's AN is detected, the listening AN notes the received power of this beacon, the channel on which it was detected, and the id.
c) With the data from b), each AN constructs an interference table (IT) which tracks the beacon signal energy detected over several channels
d) Intermittently, the AN searches its IT to switch to the channel with the least observed beacon energy (possibly its current channel).
e) When a channel change occurs, the AN signals its client/subscriber devices of the new channel.

Consider a network of 802.11h access nodes (and presumably their client devices, but as the client devices are not involved in the decision process, they are irrelevant to the interactive decision problem). Suppose the access nodes are policy constrained to operate in the eleven channels available in the 5.47-5.725 GHz European band (channels 100-140) so that the assumption that “all RTS/CTS are transmitted at the same power level” holds for all channels (in this case, the band maximum of 1 W). Thus the RTS/CTS messages transmitted by the access nodes are used as the beacon signal in this example. Further, let us assume each radio has an equal probability of being the only radio allowed to adapt at each instance. As this is just a direct application of the general DFS algorithm (where σ is now a binary function and discrete channels are used and the beacon signal is the RTS/CTS signal), we expect that the network will automatically sort itself into a low-interference frequency reuse pattern and that each adaptation will reduce the sum of observed interference in the network.

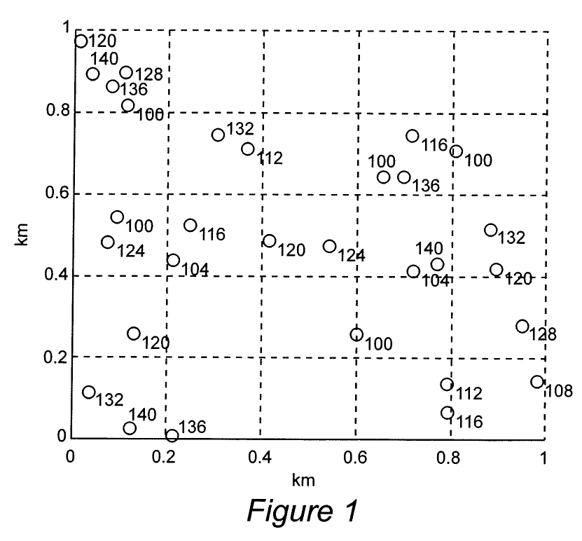

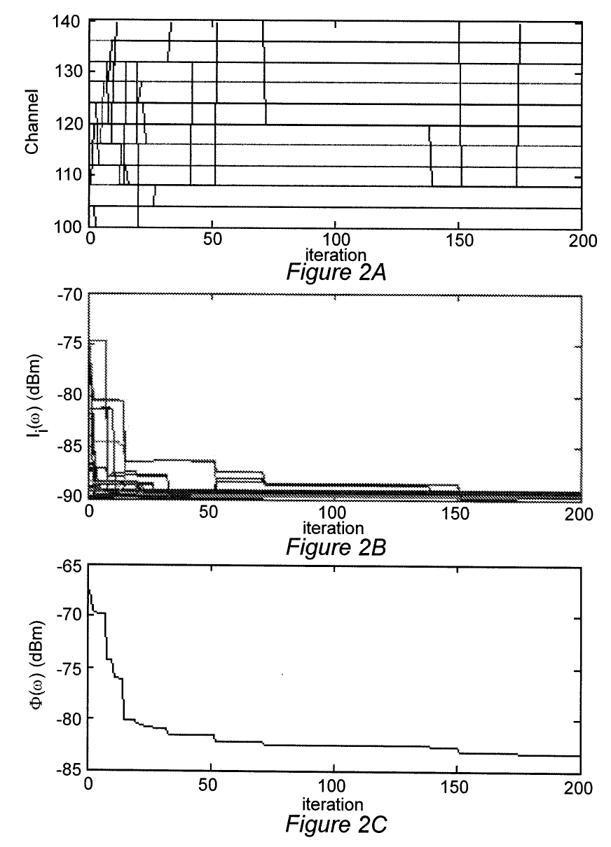

These expectations are confirmed in a simulation of thirty access nodes randomly distributed over 1 km² operating in an environment with a path loss exponent of 3 with random placements and random initial frequencies and noise powers of −90 dBm with the algorithm realized with each access node adapting to the channel with the least interfering beacon energy. The geographic distribution of devices and their final operating frequencies are shown in FIG. 1 where a circle denotes the position of an access node with its final channel id labeled just below and to the right of the circle. FIG. 2 depicts the operational channels for each access node (top), perceived interference levels by the access nodes (middle), and the sum of perceived interference levels (bottom) for the simulated network. Note that Φ(f) (bottom) decreases with each adaptation thereby satisfying the definition of an interference reducing network even though there are instances of interference increasing for individual access nodes (middle). Thus as is the case for all IRNs, self-interested adaptations led to a socially desirable outcome (at least when socially desirable is defined as the sum of observed network interference levels).

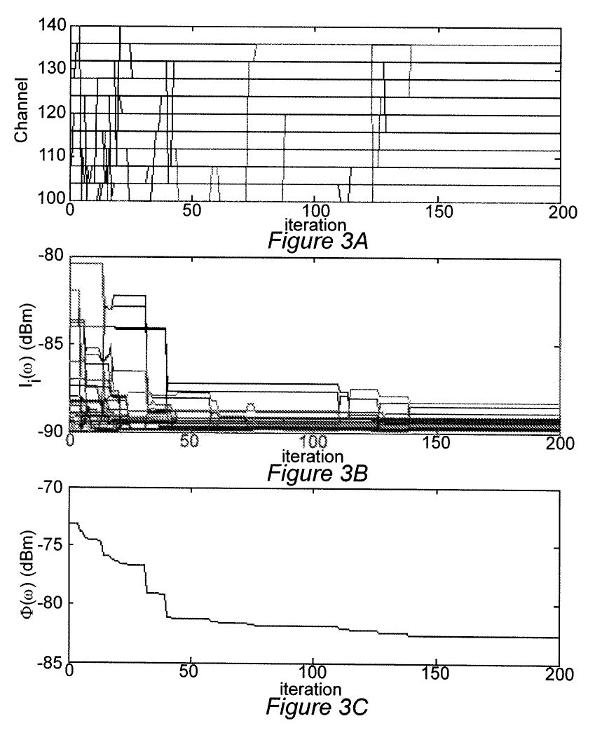

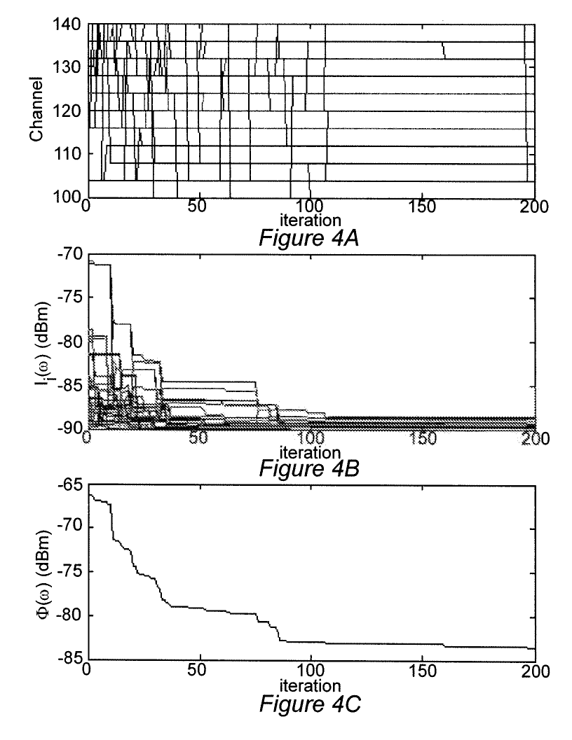

These properties still hold if the access nodes are using for all other channel selection criteria which satisfy the condition that the choice of a new channel is made only if the new channel is observed to have less cumulative RTS/CTS signal power from other access nodes. This again is the result of the network forming a potential game, which by Neel et al. [2] holds that all sequences of preferable adaptations on a compact action space (in this case, a finite number of channels with a finite number of access nodes) converge to a maximizer of the potential function and thus a minimizer of Φ(f). As the set of frequency vectors that minimize Φ(f) is not a function of the channel selection criteria, all criteria where a new channel is chosen only if the new channel is observed to have less cumulative RTS/CTS signal power from other access nodes have the same set of steady-states (though with numerous minimizers of (f), different steady-state frequency vectors may be achieved). This phenomenon is evidenced in variations of the previous simulation where each access node chooses the lowest channel or the highest channel that is observed to have a lower RTS/CTS signal power than its current channel as shown in FIGS. 3 and 4, respectively.

### Policy Variations

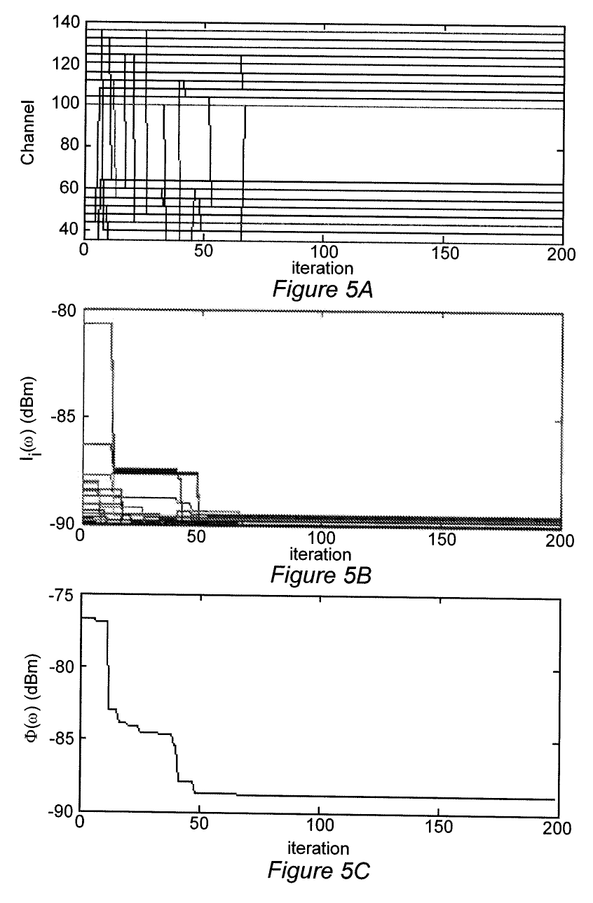

If we permit the radios to choose permissible channels beyond channels 100-140, the assumption that all RTS-CTS messages are transmitted at the same power level fails as the lower and middle UNII bands (channels 36-64) limit transmission power levels to 200 mW [3]. This violates C1 (pₖ=pᵢ∀i,kεN). However, for non-overlapping signals, Φ(fᵢ,fₖ)=σ(fₖ,fᵢ)=0, so the BSI condition still holds and the network is still an IRN. Repeating the previous simulation and changing only the permissible channels and reflecting the transmission power policy variation we get the instantaneous statistics shown in FIG. 5 where it is evident that the network continues to be an IRN.

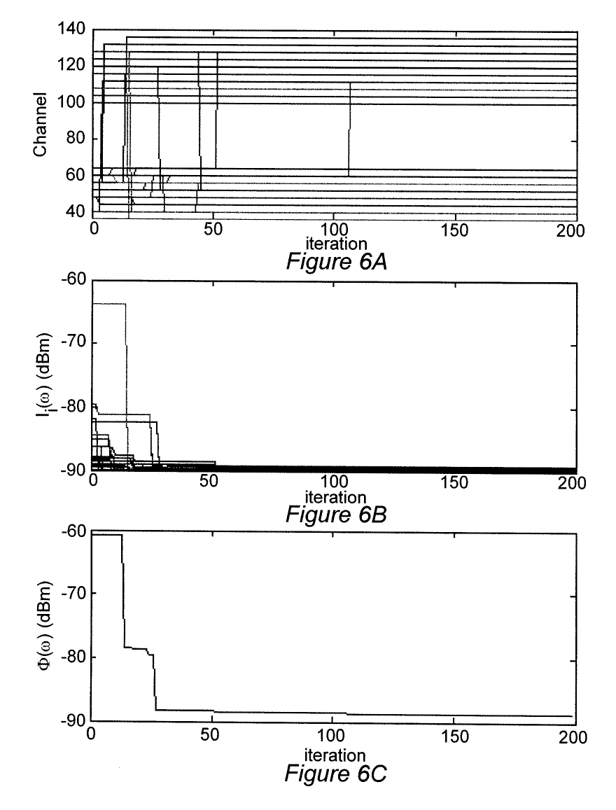

Another form of likely encountered policy variation is one where certain access points have been configured to only operate on a subset of the available channels. Because in such a scenario the action space (set of possible channel vectors) is just a compact subset of the original network, the network remains an exact potential game and an interference reducing network. However, because the action space is different, the set of interference minimizing frequency vectors will also generally be different (unless the original set of minimizers is also contained in the reduced action space) [10]. An example of this phenomenon is shown in FIG. 6 where ten access nodes have been constrained to only operate in the lower set of channels. Note that the networks simulated in FIGS. 2, 3, and 4, can also be viewed as policy-constrained subsets of the network simulated in FIG. 5 where all access nodes are constrained to operate only in the upper UNII band.

### Asynchronous Timing

In the preceding, we assumed that one and only one access node adapted at any instance in time. However, because adaptations and observation processes do not occur in infinitesimal periods of time it is likely that multiple access nodes will occasionally adapt simultaneously—a trend that becomes more likely as the number of access nodes in the network increase. So assuming C4 does not hold and continuing the policy violation of C1, we now assume each access has an opportunity to adapt at each iteration with non-zero probability.

Following the algorithm considered in this paper and the relaxed timing constraint two radios which are operating in the same channel and in close proximity to each other could simultaneously choose to adapt to another channel where a distant radio is operating. In this case, Φ(f) would increase even though each radio chose the channel which the radio had measured as having the least interference. Thus with C4 relaxed, the proposed algorithm cannot be guaranteed to yield the strict monotonicity required by the definition of an IRN.

Yet this network will still converge to a steady-state with that is a minimizer of Φ(f). This again is a result of <N,F,{uᵢ}> forming an exact potential game. As it is an exact potential game, minimizers of Φ(f) are Nash equilibria and the game has the finite improvement path property which means that from any starting state, every sequence of self-interested unilateral adaptations must terminate in a minimizer of Φ(f) [2]. Due to these two properties, the network can be modeled as an absorbing Markov chain where minimizers of Φ(f) are the absorbing states of the chain. By virtue of being a minimizer, there can be no unilateral deviations that reduce interference; thus minimizers are absorbing states. By virtue of the finite improvement path property, there always exists a sequence of adaptations that terminate in a minimizer with non zero probability as long as the probability of a unilateral deviation is always nonzero. Thus even with C4 relaxed to asynchronous timings for adaptations, the network will still converge to a minimizer of Φ(f).

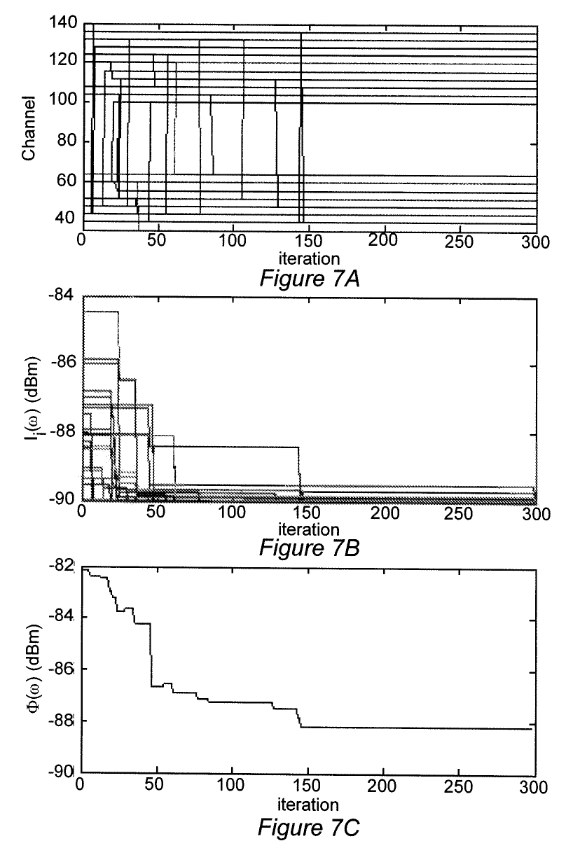

To verify this assertion, we modified the preceding simulation so that at each iteration each access node had an opportunity to adapt with probability 0.02. The instantaneous statistics for this simulation are shown in FIG. 7. While Φ(f) still trends down, it is no longer doing so monotonically. Nonetheless, because this system forms an absorbing Markov chain, it eventually converges to a frequency vector that is a minimizer of Φ(f).

### Private Frequency Preferences

Throughout this discussion we have assumed (C2) that each access node only intends to minimize the interference it perceives from other adaptive access nodes. However, because of the presence of interferers or because of local channel conditions, different access nodes may also exhibit different preferences for different frequencies. If we denote the frequency preferences of access node i as Sᵢ(fᵢ) these preferences might be incorporated as shown in (3).

$${\tilde{u}}_{i} ( f ) = - {\sum }_{k ∈ N \backslash i} {g}_{kj} {p}_{k} σ ( {f}_{i} , {f}_{k} ) - {S}_{i} ( {f}_{i} ) \qquad ( 3 )$$

### Note that Sᵢ(fᵢ) indicates that this component for access node i is only a function of access node i's choice of frequency and makes the most sense express additively as in (3) when Sᵢ(fᵢ) models the influence of static interferers.

Under the assumption that Sᵢ(fᵢ) models static interferers in the environment (2) no longer reflects the sum network interference. Instead sum network interference with frequency preferences is given by (4).

$${Φ}^{S} ( ω ) = {\sum }_{i ∈ N} ( {S}_{i} ( {f}_{i} ) + {\sum }_{k ∈ N \backslash i} {g}_{ki} {p}_{k} σ ( {f}_{k} , {f}_{i} ) ) \qquad ( 4 )$$

### This inclusion of additional interferers/jammers may also impact bilateral symmetric as the interferers may not be transmitting at the same power level as the cognitive radios or may be operating with differing bandwidths.

Regardless of the loss of bilateral symmetric interference due to variances in the static interferers, (N,Ω,{uᵢ}) remains an exact potential game but with an exact potential function given by (5).

$${V}^{S} ( ω ) = - {\sum }_{i = 1}^{n} ( {S}_{i} ( {f}_{i} ) + {\sum }_{k = i + 1}^{n} {g}_{ki} {p}_{k} σ ( {f}_{k} , {f}_{i} ) ) \qquad ( 5 )$$

Note that the differences between (4) and (5) imply that the network is not strictly an IRN. Consider the scenario where a unilateral adaptation is made from a channel that is originally only occupied by the adapting access node i and a static interferer to a channel that is occupied only by access node k such that (6) holds.

gₖⱼpₖσ(fᵢ,fₖ)<Sᵢ(fᵢ)<2gₖⱼpₖσ(fᵢ,fₖ) (6)

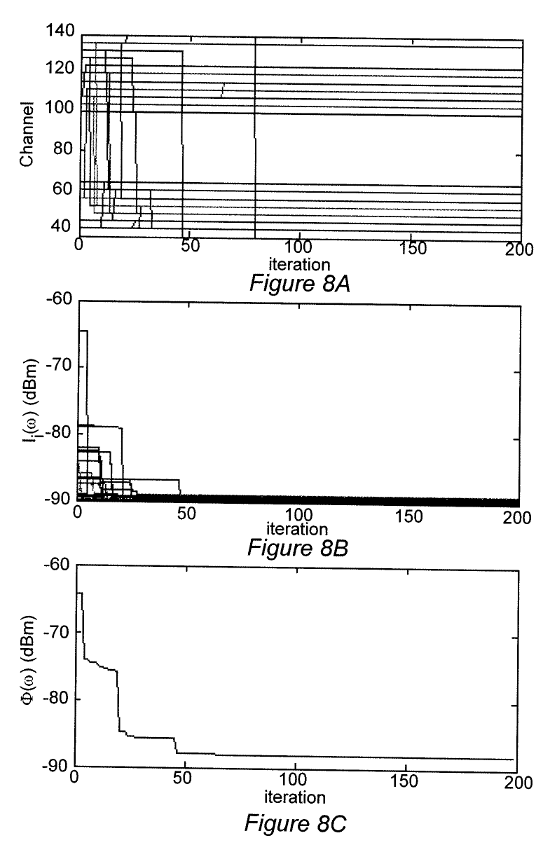

This adaptation would increase (3)—thereby satisfying the proposed algorithm—but (4) would also increase—violating the definition of an IRN. However, the exact potential in (5) will always increase, ensuring the algorithm's convergence. And when the only maximizers of (5) are those for which Sᵢ(fᵢ)=0 ∀iεN, the algorithm will converge to a minimizer of (4) as for this condition Φ^{S}(f)=−2V(f). Even though it is trivial to constrict two-access node, two channel, single interferer scenario with non-random geographic and channel distributions where (6) is satisfied, repeated trials of our randomly placed, random initial channel simulation have not yielded an adaptation that satisfies (6), which indicates the condition might be rare in practical settings. For example, modifying the policy variation simulation so it includes five static interferers operate in both channels 132 and 136, but distributed randomly geographically yield the simulation shown in FIG. 8.

### Effect of Estimations

Throughout the preceding, we have implicitly assumed that the access nodes are perfectly measuring the signal strength of the beacons (RTS/CTS signals). However, in a practical setting, measurements of interference levels in differing channels would be corrupted by noise and thus only be estimations. In such a scenario, the access nodes' goals would again take the form as shown in (3) but with Sᵢ(fᵢ) a stochastic variable. As shown in the preceding section, a goal of the form of (3) implies that while <N, F, {uᵢ}> is still an exact potential game, the network will not necessarily remain an IRN for all possible realizations.

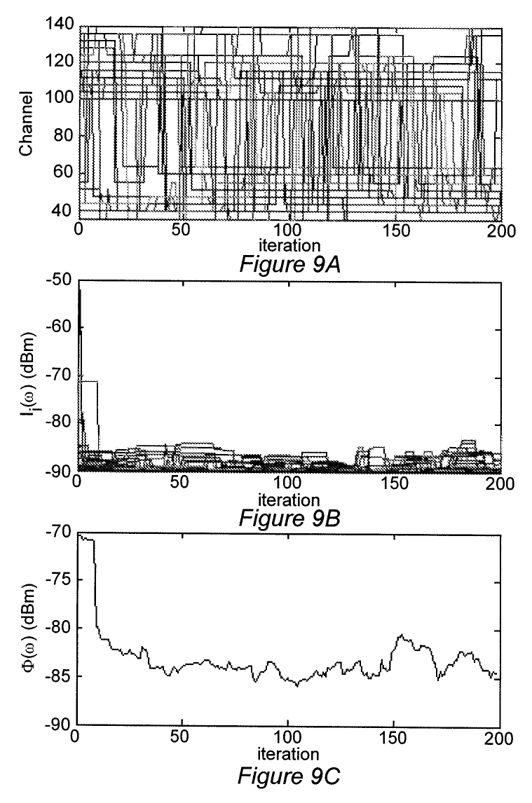

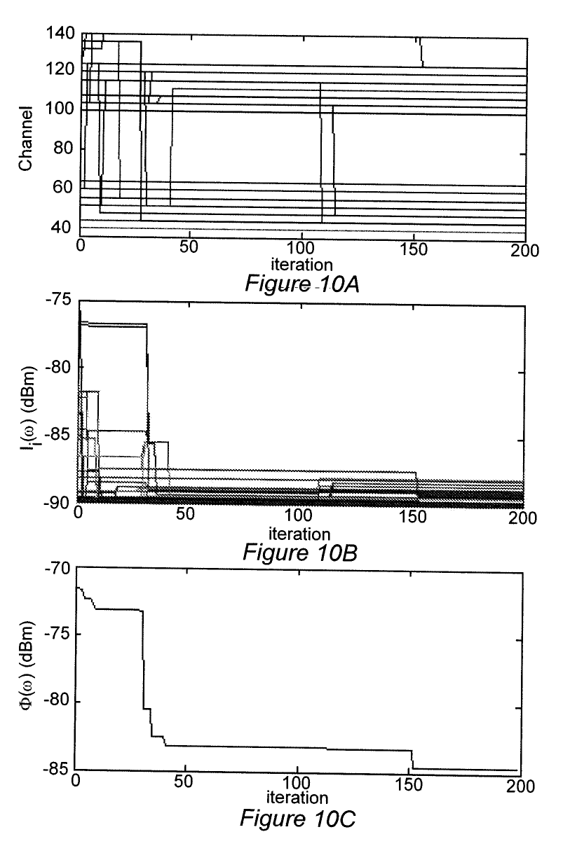

Further, for channels with very low interference levels, Sᵢ(fᵢ) may be a dominant term and its natural time variation may spawn unnecessary adaptations. For example consider a modification of the preceding simulation where the −90 dBm noise floor is implemented as a Gaussian stochastic variable whose results are shown in FIG. 9. While the algorithm in this example still yields an almost 15 dB reduction in interference levels from the initial random distribution, Φ(f) is no longer monotonic, overall performance is decreased and significant bandwidth would be wasted signaling all of these adaptations. However, by modifying the algorithm so the access nodes only adapt if the improvement in performance is predicted to be more than a small threshold (−85 dBm or 3.16 pW), the system behaves as shown in FIG. 10—generally like a convergent IRN, but with the caveat that there exists the small probability that an adaptation may increase sum interference.

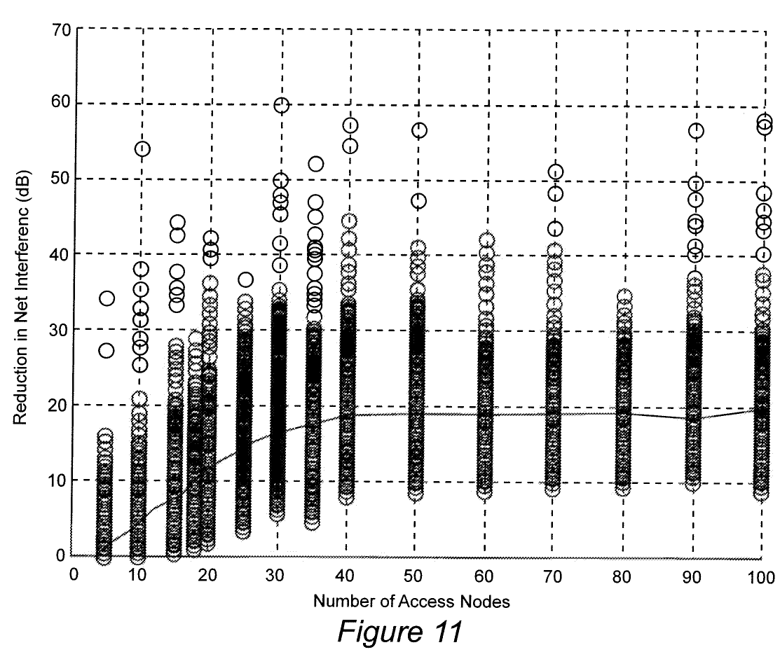

Although potential game theory and the interference reducing network design framework analytically guarantees convergence to an minimally interfering frequency vector, it does not specify the improvement gain that this system would experience as such gains are highly dependent on the initial configuration of the access nodes and their relative locations. To provide the reviewer with a sense of the possible improvements that can be realized by this system, we conducted repeated simulations of varying number of 802.11a access nodes randomly distributed over 1 km² with random initial frequencies. This simulation was conducted for 5, 10, 15, 18, 20, 25, 30, 35, 40, 50, 60, 70, 80, and 100 access nodes with 500 random trials for each number of access nodes. The results of this simulation are presented FIG. 11 where each circle depicts the aggregate system-wide reduction in interference, and the line traces out the average reduction in interference. As can be seen for access node densities >40/km² the typical reduction in interference was about 19 dB over the system's initial random frequencies with less improvement seen for lower access node densities. As should be expected, for low access node densities, there is typically little improvement gain seen by this algorithm. (In theory, improvement for a single access node system is impossible as it has no interfering access nodes.)

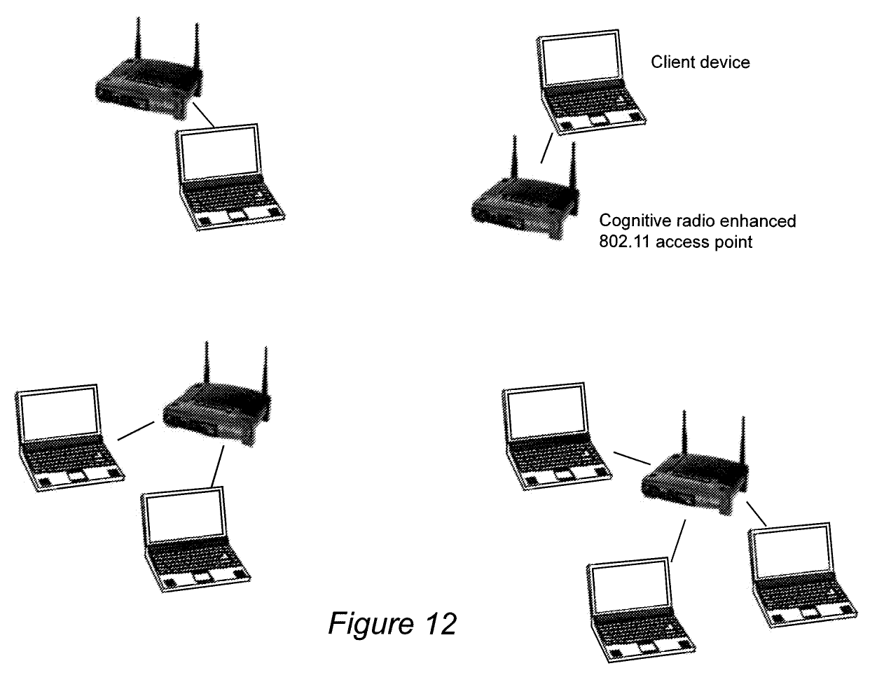

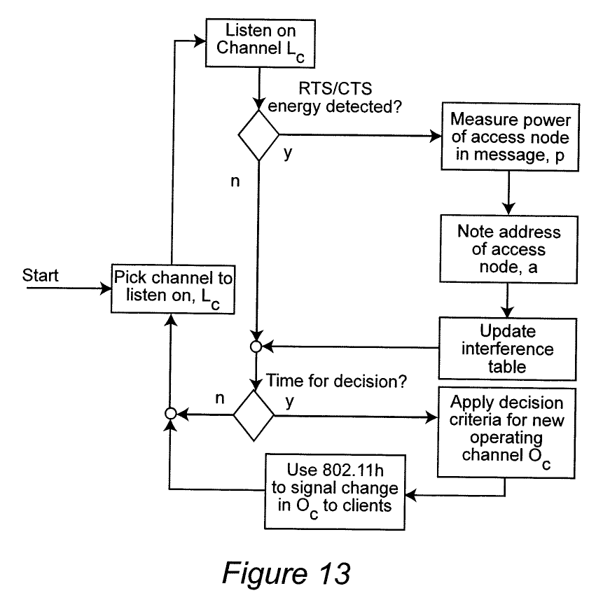

FIG. 12 is a schematic showing a typical deployment scenario with a plurality of access nodes (AN), each with one or more client devices associated with a cognitive radio enhanced 802.11 access point. For an implementation in an 802.11 networks where the beacon used is the RTS/CTS signals transmitted by the access nodes, these steps are illustrated in FIG. 13 as a flowchart where the access point initially picks a channel to listen to, L_{C}, while continuing to operate on its operating channel O_{C} where O_{C} and L_{C} may be the same channel and must be chosen from the set of allowable channels as constrained by the relevant spectrum regulation body. If a RTS/CTS signal is detected, the received strength of the detected access point is used to update an interference table maintained by the access point in the entry associated with L_{C}. To update the entry the table could use one of several different methods including averaging the detected received signal strengths from the other access point and use the most recently detected value. If the access node determines that it is time for a decision (perhaps via a random internal timer, a deterministic clock, or a combination of performance and time), the access node picks a new operational channel whose entry in the interference table is less than the one associated with O_{C}. If no such entry exists, then the access node (and its network) continues to operate on the current O_{C}. If a change in operating channel is made, the access node signals its client nodes via the messages defined in 802.11h or some other appropriate messaging scheme. After these steps, the radio picks a channel to listen to from among its available channels (of which the previous L_{C} is considered a member of the set.)

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method by which any infrastructure based wireless network whose access nodes (AN) broadcast a signal (beacon) at a common transmit power on its operating channel will autonomously converge to a near-optimal frequency reuse pattern from arbitrary initial channel allocations, comprising the following steps:
listening, at each AN, for a signal beacon on an operating channel and on one or more alternate channels;
noting, at an AN which detects during said listening step another signal beacon of another cluster's AN, a received power for said another signal beacon, a channel on which said another signal beacon is detected, and an identification (ID) for said another signal beacon;
constructing at each AN an interference table (IT), using data obtained from said noting step, which tracks a beacon signal energy detected over several channels;
searching an IT at each AN for a channel to switch to based on one or more criteria; and
changing channels at one or more AN's based on said one or more criteria and said one or more AN's notifying at least one of client and subscriber devices of a new channel.

2. The method of claim 1 wherein said searching step is performed intermittently.

3. The method of claim 1 wherein said one or more criteria used in said searching step includes selecting a channel to switch to with a least observed beacon energy.

4. The method of claim 3 wherein said channel to switch to includes a current channel.

5. The method of claim 1 wherein said one or more criteria in said searching step includes an AN adapting to any channel which has an entry in its IT with less observed beacon energy.

6. The method of claim 1 where different ANs have different available channels.

7. The method of claim 1 wherein different channels have different common beacon transmit power levels.

8. The method of claim 1 wherein only a subset of ANs of said infrastructure wireless network perform said listening, constructing, noting, searching and changing steps.

9. The method of claim 1 wherein different sets of ANs of said infrastructure wireless network have different criteria used in said searching step.

10. The method of claim 1 wherein said infrastructure based wireless network is an 802.11 network operating in infrastructure mode wherein said signal beacons are BSSID signals.

11. The method of claim 1 wherein said infrastructure based wireless network is an 802.11 network operating in infrastructure mode where said signal beacons are RTS/CTS signals transmitted by access nodes.

12. The method of claim 1 wherein said noting step notes said power of said another signal beacon from a most recent observation.

13. The method of claim 1 wherein said noting step notes said power as a weighted average of past beacon power measurements from a same AN on a same channel.

14. The method of claim 1 further comprising a step of responding to dropped connections by automatically rescanning and reattaching to an AN with a same broadcast ID.

15. The method of claim 1 further comprising the step of for a non-adapting AN (NAN) in said infrastructure based wireless network updating its IT by reassigning a channel of entry of an adapting AN (AAN) which the NAN has decoded the channel switching methods of the AAN performing the changing step.

16. A method of distributed autonomous dynamic frequency selection in a radio system comprising the steps of:
establishing a collection of coexisting 802.11 networks where each access node in the network is a cognitive radio;
observing by each of said cognitive radios spectral energy of RTS/CTS (request-to-send/clear-to-send) messages transmitted by other acces nodes in the network;
constructing and maintaining by each of said cognitive radios a table that cumulatively tracks the RTS/CTS signal strengths; and
intermittently switching channels by each of said cognitive radios to any other channel that has been observed to have less RTS/CTS access node power as indicated by the table to converge to a near optimal frequency reuse pattern.

17. A low complexity distributed autonomous dynamic frequency selection radio system which converges to a near optimal frequency reuse pattern comprising:
a collection of co-existing 802.11 networks where access nodes have been upgraded to behave as cognitive radios;
each of said cognitive radios observing spectral energy of RTS/CTS (request-to-send/clear-to-send) messages transmitted by other access nodes in the network, constructing and maintaining a table that cumulatively tracks the RTS/CTS signal strengths, and intermittently switches channels to any other channel that has been observed to have less RTS/CTS access node power as indicated by the table.
